(19) United States
(12) Patent Application Publication
(10) Pub. No.: US 2012/0205852 A1
(43) Pub. Date: Aug. 16, 2012

(54) PART-HOLDING ASSEMBLY

(76) Inventor: John B. Coleman, Kingsville, MO (US)

(21) Appl. No.: 13/026,663

(22) Filed: Feb. 14, 2011

(51) Int. Cl. B25B 1/24

(52) U.S. Cl. 269/278

(57) ABSTRACT

A part-holding assembly for use with a vise having a pair of jaws movable relative to one another. The part-holding assembly has a plurality of elongated, parallel blocks that are supported for relative movement on a pair of elongated parallel guide rods. A first one of the blocks may be removably positioned adjacent to the stationary jaw of the vise and has first and second spaced-apart cavities formed therein. A second one of the blocks may be removably positioned adjacent to the moveable jaw of the vise and has a first generally horizontally-extending through-hole aligned with the first cavity of the first block and a second generally horizontally-extending through-hole aligned with the second cavity of the first block. A third one of the blocks is positioned between the first block and the second block and has a first generally horizontally-extending through-hole aligned with the first cavity of the first block and a second generally horizontally-extending through-hole aligned with the second cavity of the first block. Linear bearings are positioned within the through-holes of the second and third blocks to permit the blocks to slide along the guide rods. The first and second blocks also include structure for removably attaching the part-holding assembly to the jaws of the part-holding assembly.

### BACKGROUND

Vises, clamps, and other part-holding assemblies are commonly used in machining operations to hold various parts so that they can be drilled, bored, tapped, grinded, reamed, or otherwise machined by a computer numerical control (CNC) machine or other device. Unfortunately, conventional vises are only configured to hold one part at a time and are therefore inefficient when multiple parts need to be machined.

Vises with multiple jaws that hold multiple parts have been developed to permit more rapid machining operations; however, existing multi-part vises suffer from several disadvantages that limit their utility.

### SUMMARY

The present invention solves the above-described problems and provides a distinct advance in the art of vises, clamps, and other part-holding assemblies.

An embodiment of the invention is a part-holding assembly for use with a vise having a pair of jaws movable relative to one another. The part-holding assembly broadly comprises a plurality of elongated, parallel blocks that are supported for relative movement on a pair of elongated parallel guide rods.

A first one of the blocks may be removably positioned adjacent to the stationary jaw of the vise and has first and second spaced-apart cavities formed therein. A second one of the blocks may be removably positioned adjacent to the moveable jaw of the vise and has a first generally horizontally-extending through-hole aligned with the first cavity of the first block and a second generally horizontally-extending through-hole aligned with the second cavity of the first block. A third one of the blocks is positioned between the first block and the second block and has a first generally horizontally-extending through-hole aligned with the first cavity of the first block and a second generally horizontally-extending through-hole aligned with the second cavity of the first block.

The guide rods support the blocks in a parallel configuration and permit the blocks to slide relative to one another. The guide rods each have one end attached within the first cavity of the first block and an opposite end that extends through the through-holes of the second and third blocks.

Linear bearings are positioned within the through-holes of the second and third blocks to permit the second and third blocks to easily slide along the guide rods. This allows the blocks to be easily moved relative to one another to accommodate various sized parts, to be loosened after the parts have been machined and are ready to be removed from the apparatus, and to be subsequently repositioned to hold other parts.

The first and second blocks also include structure for removably attaching the part-holding assembly to the jaws of the vise. This permits the assembly of the present invention to be retrofitted on nearly any conventional vise and then subsequently removed so the assembly can be attached to a different vise and/or so the vise can be used without the part-holding assembly.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a part-holding assembly constructed in accordance with embodiments of the invention and shown installed on a vise which is mounted on a milling machine table or other support surface.

FIG. 2 is a fragmentary front elevational view of the part-holding assembly, vise, and milling machine table.

FIG. 3 is vertical sectional view of the part-holding assembly, vice and milling machine table taken along the line 3-3 of FIG. 2.

FIG. 4 is vertical sectional view of the part-holding assembly, vice and milling machine table taken along the line 4-4 of FIG. 2.

FIG. 5 is an exploded perspective view of the part-holding assembly removed from the vise.

FIG. 6 is a perspective view showing the assembled part-holding assembly removed from the vise.

FIG. 7 is a perspective view of a part-holding assembly constructed in accordance with another embodiment of the invention with a number of parts being held thereby.

FIG. 8 is a perspective view of a part-holding assembly constructed in accordance with yet another embodiment of the invention with a number of parts being held thereby and one part shown removed to illustrate a feature of the part-holding assembly.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

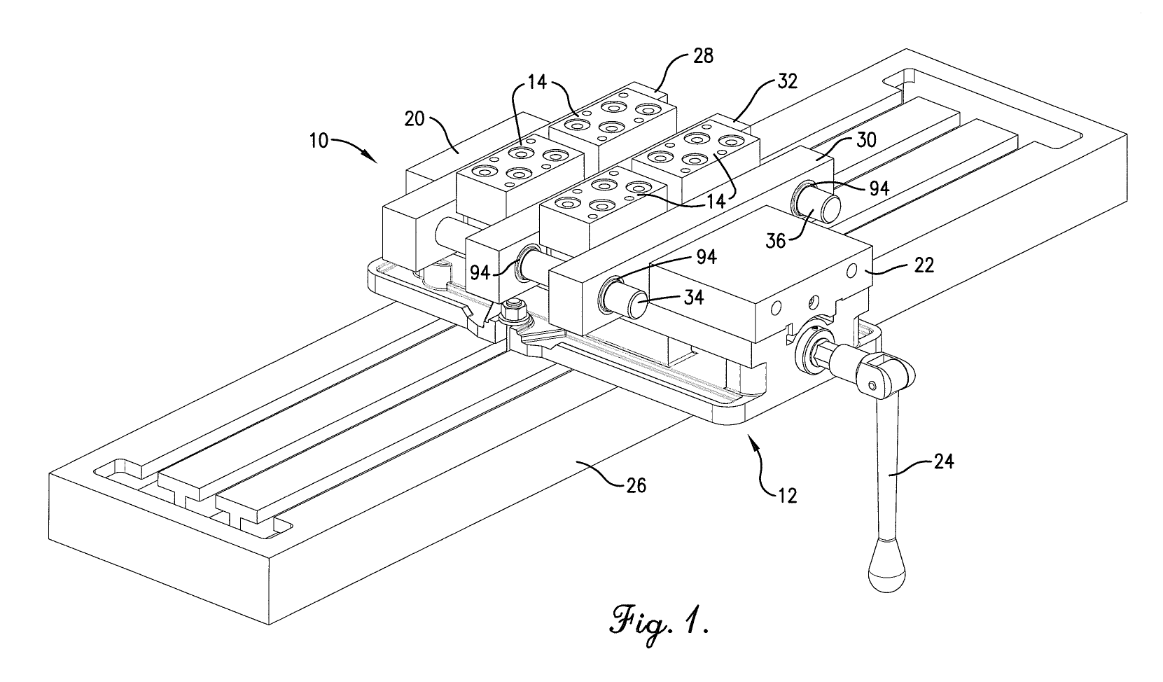

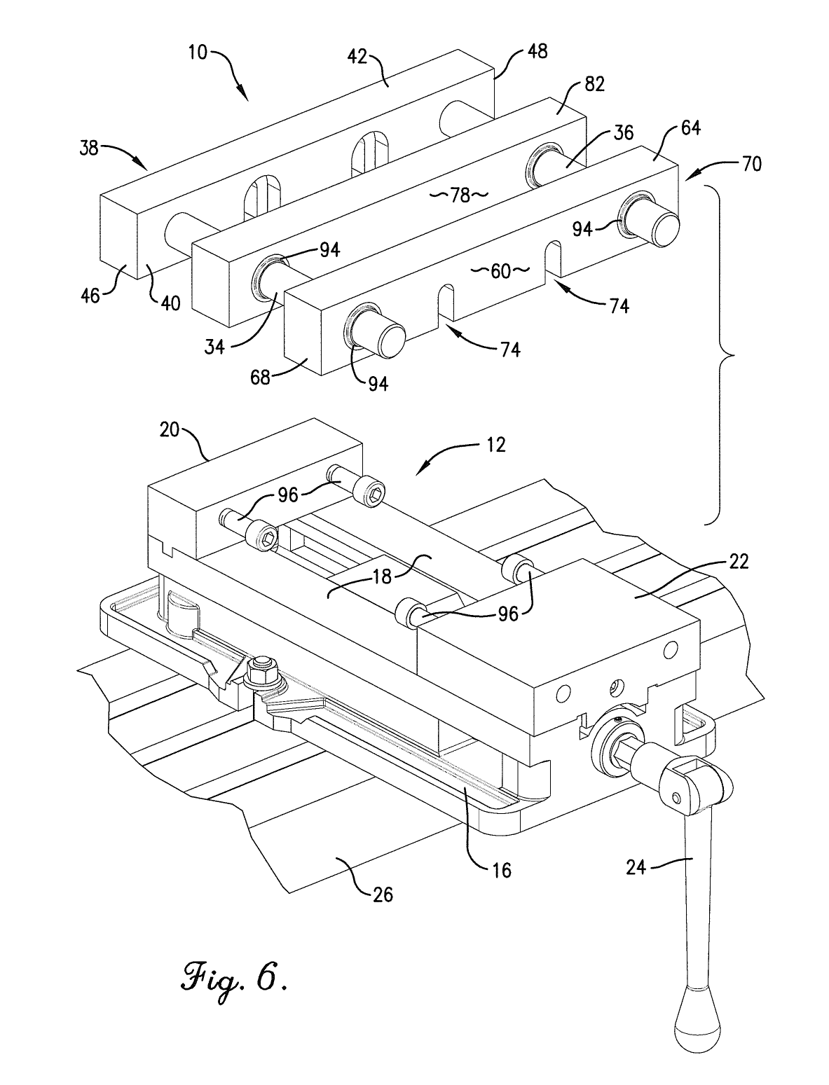

Turning now to the drawing figures, and initially FIGS. 1 and 6, a part-holding assembly 10 constructed in accordance with an embodiment of the invention is illustrated. The part-holding assembly 10 is configured to be removably attached to a conventional vise 12 for clamping or otherwise holding multiple parts 14 to be machined. Although the part-holding assembly 10 and vise 12 may be used to hold any parts for any type of manual or automatic drilling, boring, etc., they are particularly suited for holding parts to be machined by a CNC machine or other automatic machining system.

The vise 12 has a base 16, a vise bed 18 positioned atop the base, and a pair of jaws 20, 22 supported on top of the vise bed. One of the jaws 20 may be stationary and the other 22 may be moved toward and away from the stationary jaw by a linear transfer mechanism operated by a hand crank 24 or other mechanism. The base 16 of the vise may be bolted or otherwise affixed to a slotted milling machine table 26 or other support platform that may then be placed in a CNC machine or other machining system or tool.

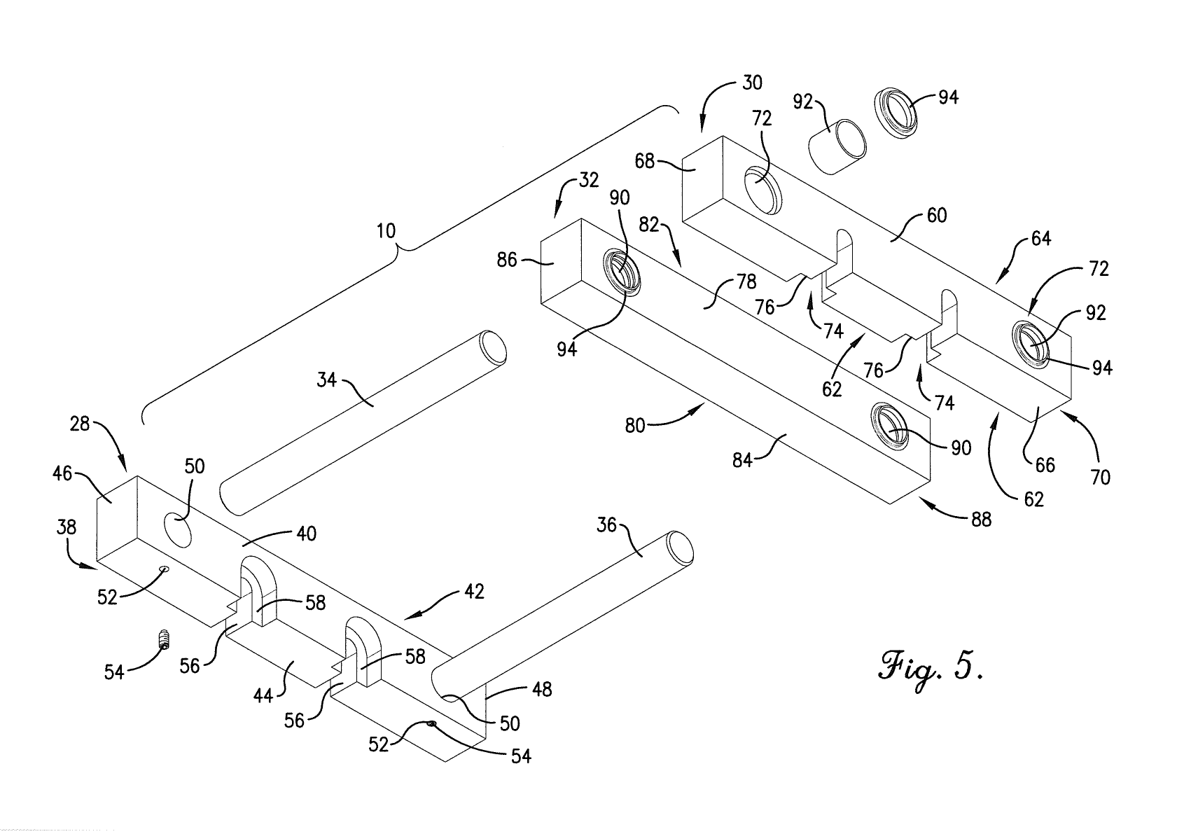

As best illustrated in FIG. 5, an embodiment of the part-holding assembly 10 broadly comprises a plurality of elongated parallel blocks 28, 30, 32 that are supported for relative movement on a plurality of guide rods 34, 36. The blocks and guide rods may be formed of any suitable materials such as heavy duty carbon steel and may be of any shape or size. The assembly 10 may include any number of blocks—the number being limited only by the distance between the two jaws of the vise. Likewise, the assembly 10 may include any number of guide rods. In the embodiment described and illustrated herein, the assembly 10 includes three blocks supported on two guide rods.

The first block 28 is generally rectangular and has outer and inner vertically-extending faces 38, 40, top and bottom horizontally-extending faces 42, 44, and vertically-extending end faces 46, 48. In one embodiment, the first block is 13.0 inches long, 1.5 inches wide, and 2.0 inches tall, but it can be formed in other sizes without departing from the scope of the invention. The outer face 38 of the block engages the stationary jaw 20 of the vise and the opposite inner face 40 provides a generally vertical part-engaging surface.

The inner face 40 of the block 28 includes a pair of spaced-apart, horizontally-extending, rod-receiving cavities 50 positioned near its outer ends. Vertically-extending threaded screw holes 52 extend from the bottom face 44 and intersect each of the cavities 50 for receiving threaded set screws 54, the purpose of which is described below. The block 28 also includes a pair of inverted U-shaped slots 56 that open toward the bottom face 44. Each slot 56 has a recessed ledge 58, the purpose of which is also described below.

The second block 30 may be of a similar shape and size as the first block 28, and has outer and inner vertically-extending faces 60, 62, top and bottom horizontally-extending faces 64, 66, and vertically-extending end faces 68, 70. In one embodiment, the second block is 13 inches long, 1.5 inches wide, and 2.0 inches tall, but it can also be formed in other sizes without departing from the scope of the invention. The outer face 60 of the block engages the moveable jaw 22 of the vise and the opposite inner face 62 provides a generally vertical part-engaging surface.

The block 30 includes a pair of spaced-apart, horizontally-extending through-holes 72 each aligned with one of the cavities 50 in the first block. The block 30 also includes a pair of inverted U-shaped slots 74 with recessed ledges 76, the purpose of which is also described below.

The third block 32 may also be of a similar shape and size as the first block 28, and has vertically-extending side faces 78, 80, top and bottom horizontally-extending faces 82, 84, and vertically-extending end faces 86, 88. In one embodiment, the block is 13 inches long, 1.5 inches wide, and 2.0 inches tall, but it can also be formed in other sizes without departing from the scope of the invention. Both faces 78, 80 of the block provide part-engaging surfaces. As with the second block, the third block also includes a pair of spaced-apart, horizontally-extending through-holes 90, each aligned with one of the cavities 50 in the first block and one of the through-holes 72 in the second block.

A cylindrical linear bearing 92 is positioned in each of the through-holes 72, 90 for facilitating sliding of the blocks 30, 32 on the rods 34, 36 as explained below. Seals 94 are positioned adjacent the open ends of the through-holes 72, 90 for preventing metal shavings and other debris from entering the through-holes and damaging the guide rods 34, 36 and/or linear bearings 92.

The guide rods 34, 36 support the blocks 28, 30, 32 in a parallel configuration and permit the blocks to move relative to one another as described below. The rods may be of any size and shape and constructed of any materials. In one embodiment, the rods 34, 36 are cylindrical in shape, approximately 9.75 inches long and 1.0 inches in diameter.

To assemble the part-holding assembly 10, a first end of each rod 34, 36 is placed within one of the cavities 50 of the first block. The set screws 54 are then screwed into the screw holes 52 to secure the rods within the cavities. Alternatively, the first ends of the rods and the inside walls of the cavities may be threaded so that the ends of the rods can be screwed into the first block. The second and third blocks 30, 32 are then supported on the rods by inserting the rods through the through-holes 72, 90 of the third block 32 and then the second block 30.

The assembled part-holding assembly 10 may then be attached to the illustrated vise 12 or any other conventional vise. Bolts 96 or other fasteners with enlarged heads are first screwed into threaded holes in the jaws of the vise as best shown in FIG. 6. The jaws 20, 22 of the vise are then separated a sufficient distance to accommodate the part-holding assembly 10. The assembly 10 is then placed on the vise bed 18 so that the U-shaped channels 56, 74 in the first and second blocks 28, 30 fit over the bolts 96. The bolts are then tightened until their bolt heads press firmly against the recessed ledges 58 of the U-shaped slots.

Once the part-holding assembly 10 is attached to the vise, parts 14 may be placed between the first and third blocks and/or between the second and third block and held firmly in place by operating the crank 28 or other mechanism to close the vise jaws 20, 22. Because the third block 32 may be moved along the guide rods 34, 36 independently of the first and second blocks 28, 30, parts of different sizes may be supported on either side of the third block.

After the parts 14 have been machined, the part-holding assembly 10 may be subsequently removed from the vise 12 by simply loosening the bolts 96 and then lifting the entire assembly 10 from the bed 18 of the vise. This permits the assembly to be retrofitted on nearly any conventional vise and then subsequently removed so the assembly can be attached to a different vise and/or so the vise can be used without the part-holding assembly.

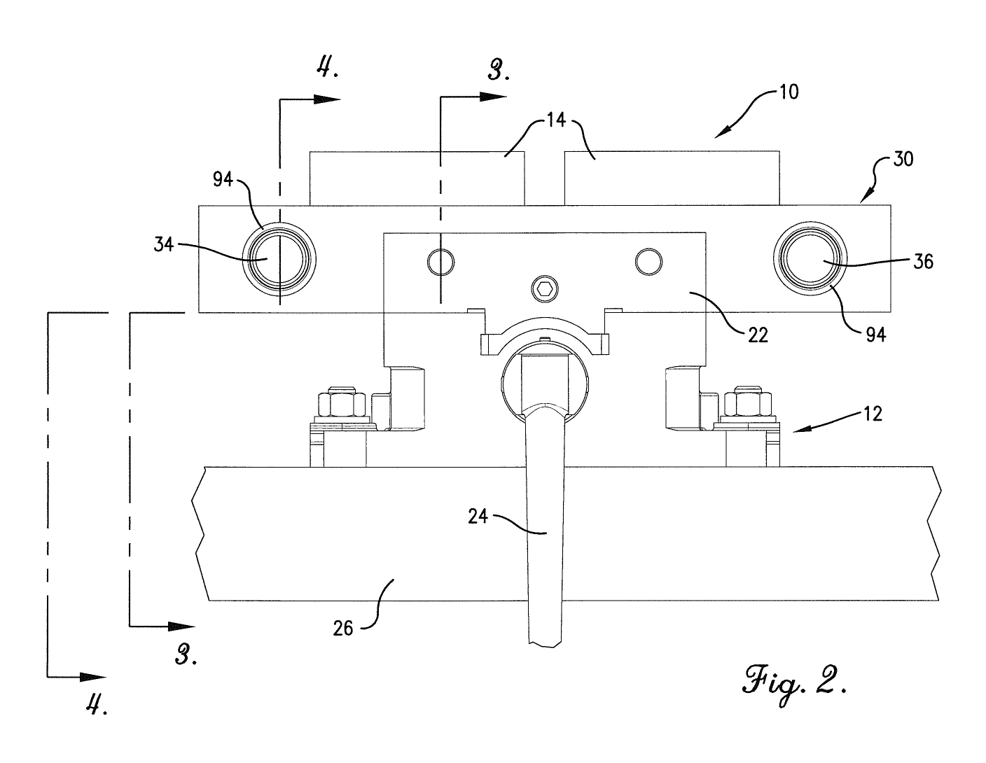

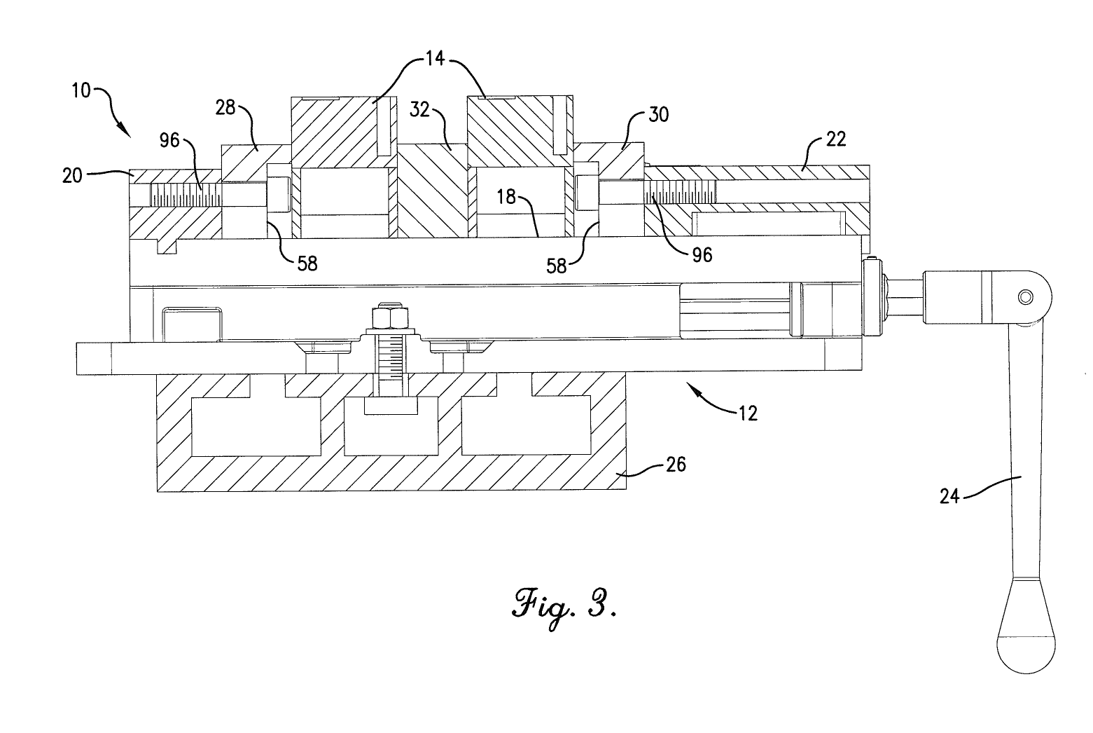

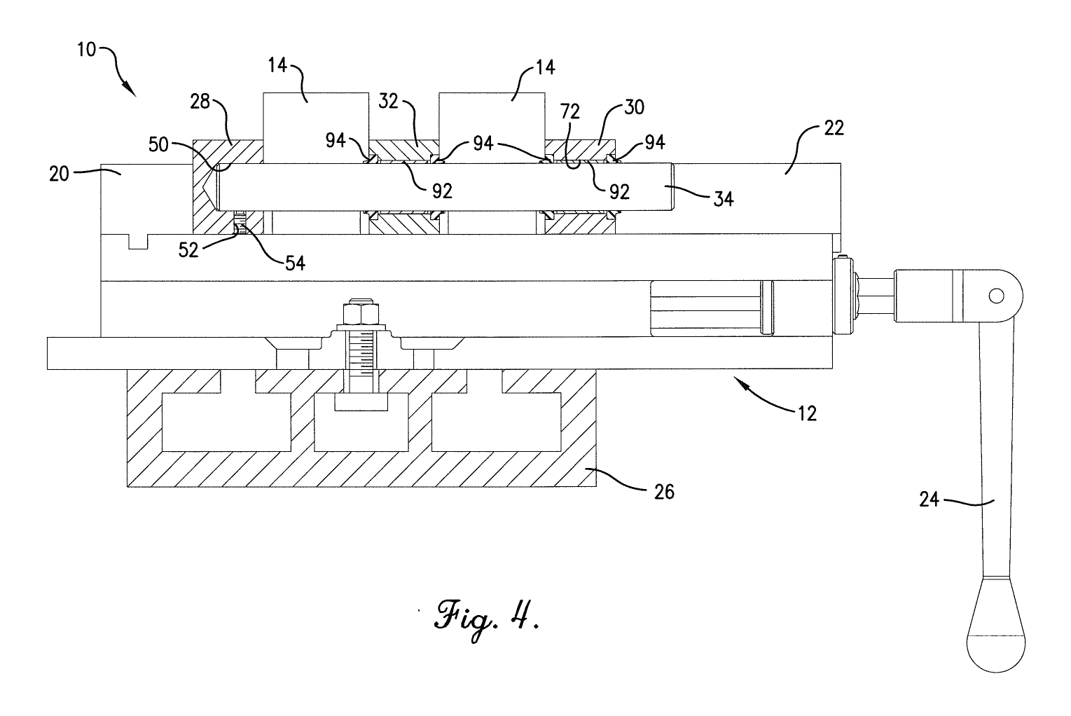

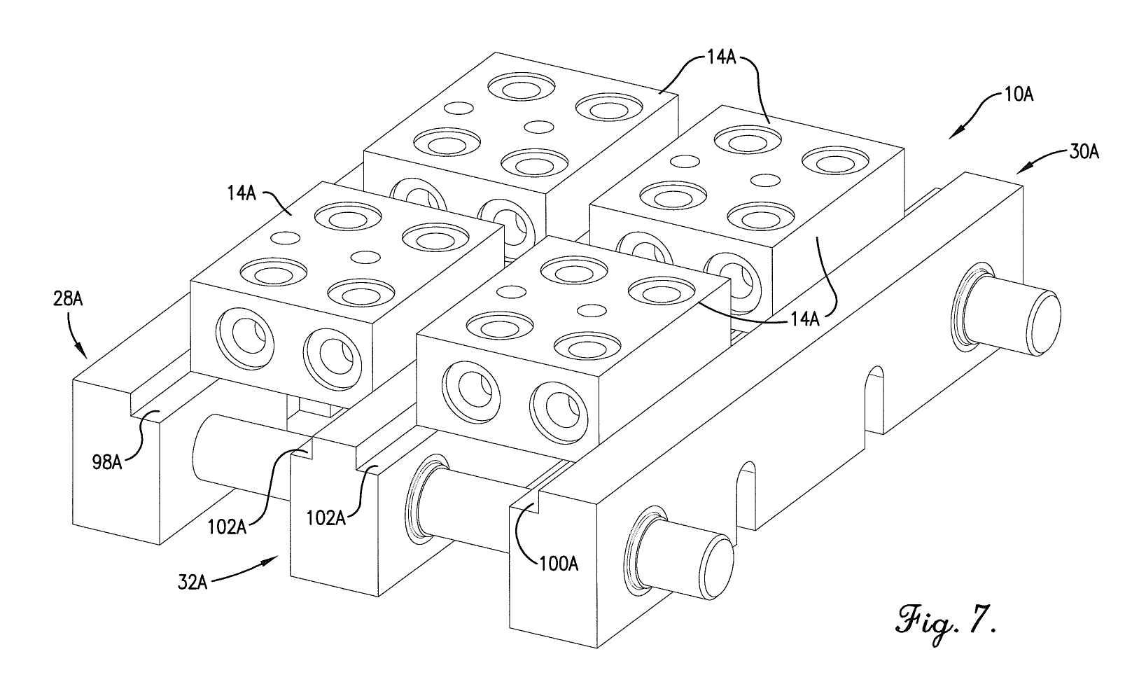

FIG. 7 illustrates a part-holding assembly 10A constructed in accordance with another embodiment of the invention. The assembly 10A is substantially identical to the assembly 10 of FIGS. 1-6 except that the first and second blocks 28A, 30A each include inwardly-recessed, L-shaped shoulders 98A, 100A along their inner faces that form orthogonal part-engaging surfaces. Similarly, the third block 32A includes inwardly-recessed, L-shaped shoulders along both of its sides that form orthogonal part-engaging surfaces. The shoulders 98A, 100A, 102A help locate parts 14A a distance above the vise bed.

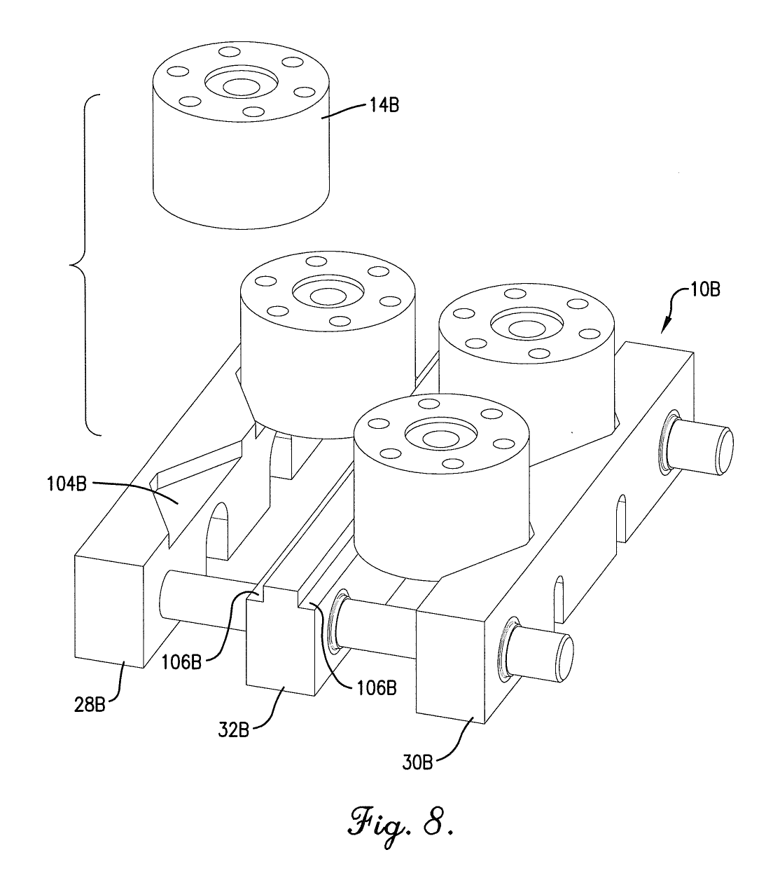

FIG. 8 illustrates a part-holding assembly 10B constructed in accordance with yet another embodiment of the invention. The assembly 10B is substantially identical to the assembly 10 of FIGS. 1-6 except that the first and second blocks 28B, 30B each include inwardly-recessed, V-shaped recesses 104B along their inwardly facing sides that form angled part-engaging surfaces. These recesses 104B facilitate the clamping of circular-shaped or angled parts 14B as illustrated. As with the embodiment of FIG. 7, the third block 32B includes inwardly-recessed, L-shaped shoulders 106B along both of its sides that form orthogonal part-engaging surfaces.

In other embodiments, one or more of the block may include tool-relief slots, recessed regions, etc. that provide room for drills and other machining devices to operate on parts held by the assembly.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

1. A part-holding assembly for use with a vise having a pair of jaws movable relative to one another, the part-holding assembly comprising:
a first elongated block that may be removably positioned adjacent to one of the jaws of the vise, the first block having first and second spaced-apart cavities formed therein;
a second elongated block that may be removably positioned adjacent to the other jaw of the vise, the second block having a first generally horizontally-extending through-hole aligned with the first cavity of the first block and a second generally horizontally-extending through-hole aligned with the second cavity of the first block;
a third elongated block positioned between the first block and the second block and having a first generally horizontally-extending through-hole aligned with the first cavity of the first block and a second generally horizontally-extending through-hole aligned with the second cavity of the first block;
a first elongated guide rod having one end attached within the first cavity of the first block and an opposite end extending through the first through-holes of the second and third blocks;
a second elongated guide rod having one end attached within the second cavity of the second block and an opposite end extending through the second through-holes of the second and third blocks; and
linear bearings positioned within the first and second through-holes of the second and third blocks to permit the second and third blocks to slide along the first and second guide rods toward and away from the first block so that the first, second, and third blocks may be moved away from one another and subsequently moved toward one another to hold parts therebetween when the jaws of the vise are moved toward one another.

2. The part-holding assembly of claim 1, wherein the first block includes structure for removably attaching the part-holding assembly to a stationary jaw of the vise.

3. The part-holding assembly of claim 1, wherein the second block includes structure for removably attaching the part-holding assembly to a movable jaw of the vise.

4. The part-holding assembly of claim 1, further comprising seals positioned adjacent the first and second through-holes of the second and third blocks for preventing debris from migrating between the guide rods and the linear bearings.

5. The part-holding assembly of claim 1, wherein the linear bearings are sleeve-style bearings formed of low friction materials.

6. The part-holding assembly of claim 1, wherein the linear bearings are linear ball bearings.

7. The part-holding assembly of claim 1, wherein the first and second guide rods are removably attached within the first and second cavities of the first block with set screws.

8. The part-holding assembly of claim 1, wherein the first and second guide rods have threaded ends, the first and second cavities have threaded inner walls, and the first and second guide rods are screwed into the first and second cavities.

9. A part-holding assembly for use with a vise having a pair of jaws movable relative to one another, the part-holding assembly comprising:
a first elongated block having structure for removably attaching to a stationary jaw of the vise, the first block also having first and second spaced-apart cavities formed therein;
a second elongated block having structure for removably attaching to a moveable jaw of the vise, the second block also having a first generally horizontally-extending through-hole aligned with the first cavity of the first block and a second generally horizontally-extending through-hole aligned with the second cavity of the first block;
a third elongated block positioned between the first block and the second block and having a first generally horizontally-extending through-hole aligned with the first cavity of the first block and a second generally horizontally-extending through-hole aligned with the second cavity of the first block;
a first elongated guide rod having one end attached within the first cavity of the first block and opposite end extending through the first through-holes of the second and third blocks; and
a second elongated guide rod having one end attached within the second cavity of the second block and an opposite end extending through the second through-holes of the second and third blocks.

10. The part-holding assembly of claim 9, further comprising linear bearings positioned within the first and second through-holes of the second and third blocks to permit the second and third blocks to slide along the first and second guide rods toward and away from the first block so that the first, second, and third blocks may be moved away from one another and subsequently moved toward one another to hold parts therebetween when the jaws of the vise are moved toward one another.

11. The part-holding assembly of claim 9, wherein the structure for removably attaching to the stationary jaw of the vise comprises a U-shaped slot for receiving a fastener fastened to the stationary jaw.

12. The part-holding assembly of claim 9, wherein the structure for removably attaching to the movable jaw of the vise comprises a U-shaped slot for receiving a fastener fastened to the moveable jaw.

13. The part-holding assembly of claim 9, further comprising seals positioned adjacent the first and second through-holes of the second and third blocks for preventing debris from migrating between the guide rods and the linear bearings.

14. The part-holding assembly of claim 9, wherein the linear bearings are sleeve-style bearings formed of low friction materials.

15. The part-holding assembly of claim 9, wherein the linear bearings are linear ball bearings.

16. The part-holding assembly of claim 9, wherein the first and second guide rods are removably attached within the first and second cavities of the first block with set screws.

17. The part-holding assembly of claim 9, wherein the first and second guide rods have threaded ends and the first and second cavities have internal threading so that the first and second guide rods are screwed into the first and second cavities.
